(19) United States
(12) Patent Application Publication
(10) Pub. No.: US 2023/0384131 A1
(43) Pub. Date: Nov. 30, 2023

(54) MODULAR FLUID FLOW SENSOR SYTEM

(71) Applicant: FlowActive, Inc., Troy, NY (US)

(72) Inventors: Matthew Cusack, Troy, NY (US); Frank Lipowitz, Rexford, NY (US); Joshua W. Bingham, Albany, NY (US)

(21) Appl. No.: 18/200,300

(22) Filed: May 22, 2023

Related U.S. Application Data
(60) Provisional application No. 63/365,222, filed on May 24, 2022.

(51) Int. Cl. G01F 1/075; G01F 1/56; G01F 15/06

(52) U.S. Cl. CPC G01F 1/0755; G01F 1/56; G01F 15/066

(57) ABSTRACT

A universal fluid flow sensor system and method installable in a toilet tank. A system is disclosed that includes a two-part water flow monitoring device, which include a dry module that contains a power source, communications and an event processing system; and a wet module releasably coupled to the dry module that receives an inflow of water and includes a turbine with magnets that generates a magnetic field when spun. The magnetic field is captured by the dry module to determine flow rate data.

### PRIORITY

This application claims priority provisional application MODULAR FLUID FLOW SENSOR SYSTEM, Ser. No. 63/365,222, filed on May 24, 2022, the contents of which are hereby incorporated by reference.

### TECHNICAL FIELD

The subject matter of this disclosure relates to fluid flow sensing and measurement systems, and more particularly to a modular Internet of Things (IoT) based sensor system having at least two modules for sensing and measuring fluid flow and leaks in household and commercial appliances such as toilets and the like.

### BACKGROUND

As water resources become scarcer and more expensive, water management in large facilities such as apartments, commercial buildings, hotels, etc., will continue to become more and more important. Among the challenges facility owners and managers face is to ensure that water waste is minimized.

One area where water waste is commonplace involves leaking bathroom appliances such as toilets. A simple slow leak may go undetected for some time as the toilet will continue to operate but will repeatedly discharge water as though it was partially flushed. More involved leaks could result in an overflow situation causing significant flood damage to the facility.

### SUMMARY

Aspects of the disclosure provide a modular Internet of Things (IoT) based system for sensing and measuring water flow and detecting leaks in household appliances such as toilets. A sensor system is provided that will automatically detect leaks, provide alerts, measure water flow, provide analytics for water use in a toilet, etc.

A modular sensor system is provided that includes a wet module and a dry module sealed from the wet module. The wet module is configured with a turbine that generates magnetic field signals when fluid passes therethrough. The dry module is fluidly sealed from the wet module and includes: a sensor for wirelessly capturing the magnetic field signals from the wet module, and an event processor for processing the magnetic field signals to generate fluid flow data.

In a first aspect, a fluid flow sensor system is provided that includes: a first module that generates magnetic field signals in response to a fluid passing therethrough; and a second module, sealed from the first module, that includes: a sensor for capturing the magnetic field signals, and an event processor system coupled to the sensor and configured to process the magnetic field signals to generate flow data associated with the fluid.

In a second aspect, a fluid flow sensor system is provided that includes: a first module that generates a wireless signal in response to a fluid passing therethrough; and a second module, sealed from the first module, that includes: a sensor for capturing the wireless signal, and an event processor system coupled to the sensor and configured to process the wireless signal to generate flow data associated with the fluid.

In a third aspect, a toilet is provided that includes a first module that generates magnetic field signals in response to a fluid passing therethrough; and a second module, sealed from the first module, that includes: a sensor for capturing the magnetic field signals, and an event processor system coupled to the sensor and configured to process the magnetic field signals to generate flow data associated with the fluid.

### BRIEF DESCRIPTION OF THE DRAWINGS

These and other features of this disclosure will be more readily understood from the following detailed description of the various aspects of the disclosure taken in conjunction with the accompanying drawings in which:

FIG. 1 shows a perspective view of a fluid flow sensor having a two-module configuration according to embodiments.

FIG. 2 shows a side view of a fluid flow sensor of FIG. 1 having a two-module configuration according to embodiments.

FIG. 3 shows a side view of an alternative fluid flow sensor system having a two-module configuration according to embodiments.

FIG. 4 shows an alternative embodiment in which the sensor is mounted to a top edge of a toilet tank according to embodiments.

FIG. 5 shows an internal component view of an illustrative fluid flow sensor having a two-module configuration according to embodiments.

FIG. 6 shows an external view of the fluid flow sensor of FIG. 5 having a two-module configuration according to embodiments.

The drawings are not necessarily to scale. The drawings are merely schematic representations, not intended to portray specific parameters of the disclosure. The drawings are intended to depict only typical embodiments of the disclosure, and therefore should not be considered as limiting the scope of the disclosure. In the drawings, like numbering represents like elements.

### DETAILED DESCRIPTION

Aspects of this disclosure include a modular Internet of Things (IoT) based system for sensing and measuring fluid flow and detecting leaks in appliances such as toilets. In one embodiment, a sensor device is provided that fits into or is integrated into the tank of a toilet, measures water flow or consumption, and communicates wirelessly with a remote data processing system that identifies leaks, reports demand data, issues alert conditions, calculates pressure, etc. In other embodiments, the sensor can reside external to the appliance.

Examples of such systems are for example described in U.S. Pat. No. 10,794,748, FLUID FLOW SENSOR SYSTEM FOR DETECTING FLOW EVENTS IN A TOILET, U.S. Pat. No. 11,015,968, FLUID FLOW SYSTEM HAVING A UNIVERSAL STEM, and U.S. Pat. No. 11,391,615, the contents of which are hereby incorporated by reference.

Almost all conventional toilets utilize water that is stored in a tank and released when flushed. After each flush, a re-fill “event” occurs within the toilet that includes a flow of water through a flexible fill tube and into an overflow tube. If there is a leak or other performance issue with the toilet (e.g., a malfunctioning flapper), the toilet will flow more water than is necessary via the fill tube during an event. In one embodiment, the sensor system only activates when water is flowing through the fill tube, thus minimizing power usage of the system. Raw data corresponding to an amount of flow is captured by the system and wirelessly transmitted to a remote data processing system for analysis.

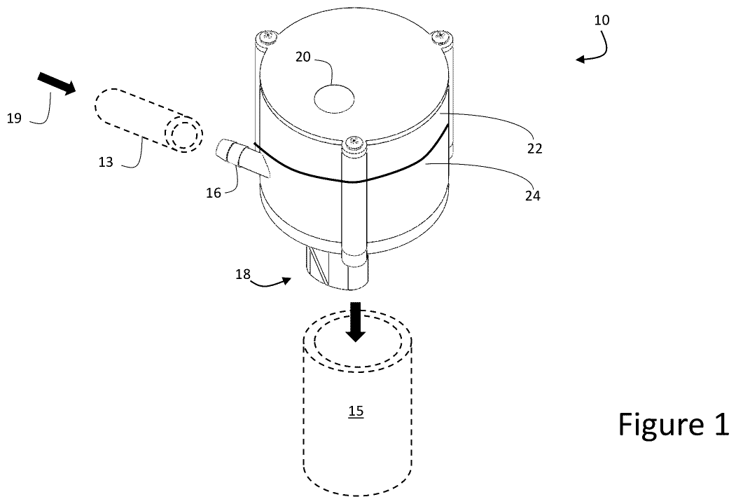

An illustrative sensor system 10 is shown in FIG. 1. Sensor system 10 includes a water monitoring device that includes two chambers or modules, including a “dry” module 22, and a “wet” module 24. The dry module 22 includes environmentally sensitive components, e.g., a power management system, a communication system, and a data processing system (e.g., a battery, a WiFi transceiver, computer processor, etc.), and is maintained in a separated, watertight, and sealed enclosure. In certain embodiments, dry module 22 does not include any moving components, but instead includes only electrical and electronic components.

The wet module 24 provides a fluidics pathway through which water passes. It includes an intake port 16 configured to connect to a fill tube 13 for receiving a flow of water 19, a turbine or wheel (not shown) which rotates in response to water flow, and an outflow port including a mounting element 18 that steers the waterflow downward to overflow tube 15. Although not shown in detail, water 19 flows through the flexible fill tube 13 into intake port 16, through the turbine, exits out through output port via mounting element 18 and exits into the overflow tube 15. The intake port 16 is sized and configured to accept a standard fill tube 13 (e.g., with ribs or a clamp). The outflow port can be sized to expel the water into overflow tube 15.

The turbine inside module 24 includes magnets that generates a magnetic field (i.e., signals) when spun. The magnetic signals change based on the speed at which the wheel spins (i.e., flow rate). A sensor, e.g., Hall effect sensor, or the like inside the dry module 22 detects the magnetic signals and is coupled to an event processing system to store and/or process the signals to generate flow rate information. Accordingly, the wet module 24 generates signals in the form of a magnetic field using mechanical components (e.g., a wheel/turbine and magnets), and the dry module 22 senses the magnetic field and generates the flow rate information separately from the wet module 24.

The two modules 22, 24 may be implemented as two separate modular components, or a single component with a dividing wall that seals and separates the two. In the case where two separate modular components are utilized, the two can releasably connect or mate with each other along a common plane, connection point or interface using, e.g., screws, fasteners, tabs, plugs, etc. An advantage of using two separate releasably attachable components is that the dry module, which contains the battery and electronics, can be replaced, upgraded, or swapped out, without having to replace the entire system, i.e., the wet module 24 can remain in place.

As noted, the two-module arrangement maintains the battery and electronics in a separate sealed water free environment, which improves the life and performance of the sensor system, serviceability and allows for flexible communication, power, pipe size, flow rate and upgrade strategies.

Dry module 22 accordingly provides the onboard power and control services necessary to run sensor system 10. In certain embodiments the electronics in the dry module 22 includes an event processing system to process individual events, e.g., flushes. Event processing system interprets flow rate information and may include a data processor and a communication system for communicating flow rate information to a remote service. The power management system of sensor system 10 may include a battery, capacitor or other energy storage/generation system. Dry module 22 may include one or more circuit boards to implement data processing services, power management, wired or wireless communication services, interface services, etc. Dry module 22 may also include an audio or visual user interface 20, e.g., to facilitate monitoring, configuration and setup of the sensor system 10.

In certain embodiments, the first housing module 22 provides an event processing system (not shown) that for example can operate in three modes to efficiently manage power consumption: (1) a low power sleep mode that detects the occurrence of an event, (2) a data collection mode that collects flow data (including a flow rates) in response to a detected event using a secondary low power mode, and (3) a communication mode to periodically or on-demand communicate collected flow data to a remote service. Accordingly, the event processing system effectively minimizes power usage of the sensor system 10.

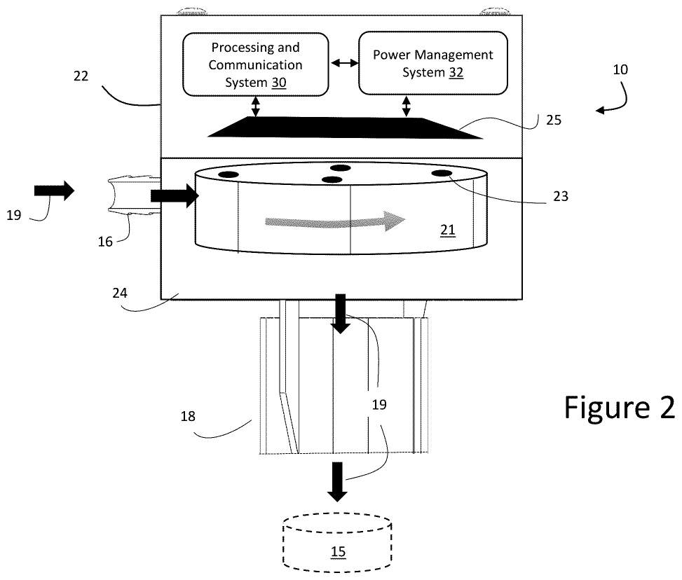

FIG. 2 depicts an internal side view of the sensor system 10 in which the wet module 24 includes turbine 21 that rotates in response to a water flow 19. Turbine 21 includes magnets 23 that rotate with the turbine 21 and generate a magnetic field. Turbine 21 may comprise any device having any shape or configuration capable of spinning or rotating in response to a fluid flow. The dry module 22 includes a sensor, such as a Hall effect sensor 25 that senses the magnetic fields and outputs a signal commensurate with the rotation. Dry module 22, in this embodiment, also includes a processing and communication system 30 (including, e.g., an integrated circuit device that implements an event processing system) and a power management system (including, e.g., a battery).

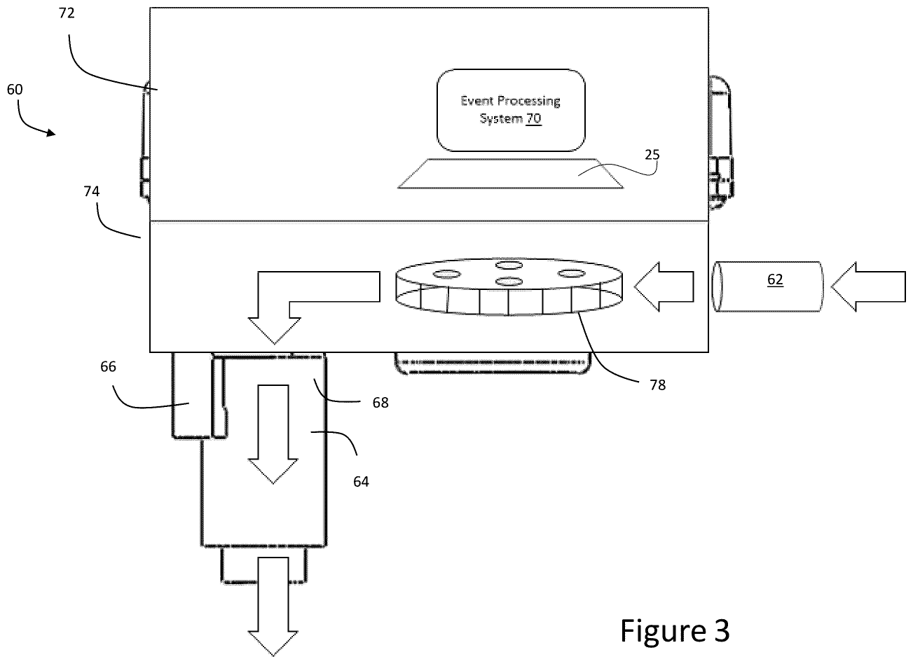

FIG. 3 depicts an alternative sensor device 60 with a two-module housing that likewise includes a dry module 72 having sealed electronics and a wet module 74 through which water flows and spins a turbine 78 to generate magnetic signals. As shown by the arrows in FIG. 3, during a flush event, water flows through flexible fill tube 62, into the wet module 74 through turbine 78, through mounting element 68 at the bottom of the wet module 74, down through the universal stem 64, and out to an overflow tube (not shown).

In some embodiments, internal probes located proximate arrow 66 detect the event and activate a data collection mode of the event processing system 70 located in the dry module 72. The probes detect a water flow event during a sleep mode and activates the data collection mode within the event processing system. In other embodiments, rather than internal probes, other sensing techniques are employed such as sampling the Hall effect sensor of the flow turbine 78.

Like the previous embodiment, dry module 72 may for example comprise a Hall effect sensor 25 that detects the magnetic field generated by magnets on the turbine 78 that rotates in response to a flow of water and emits pulses based on the speed of the turbine 78, i.e., the flow rate of the water. Namely, the greater the flow rate, the greater the frequency of pulses. Event processing system 70 may be configured to count a number of pulses during predefined time intervals during the water flow event. For example, event processing system 70 may capture a signal count value every two seconds. The result is a packet of event data consisting of a series of flow rate values for a given flow event, e.g., (t₁=20, t₂=22, t₃=19, t₄=20, t₅=21, t₆=18 . . . t₃₀=17). Each value may for example represent the number of times a turbine spun during a two second interval. These short 1-9 second intervals are frequent enough to run a statistical analysis for more detailed insights into potential problems with the water appliance or water supply.

In some embodiments, event processing system 70 can analyze the data locally, e.g., compare two samples to determine a change in the state, a change in flow rate, etc. In some instances, e.g., an emergency, the system will communicate out an emergency message immediately. In other instances, the data is transmitted at predetermined periodic times to a local server and/or cloud platform or the like for subsequent analysis.

In certain cases, the event data can be wirelessly transmitted to a remote data processing service for analysis in a communication mode. Transmission may occur at the time of the event, or any time thereafter. Transmission may also be initiated by the user or external device. In one illustrative embodiment, a collection of event data records are transmitted in a batch mode at predefined time intervals, e.g., every eight hours.

In addition to event data, device data such as continuous device health monitoring can be reported in data transmissions. Other device data may, e.g., include battery voltage, temperature, relative humidity, atmospheric pressure, ambient optical brightness, sound noise level, VOC gas sensor readings, electric current, liquid or gaseous hydrogen-based fuels, etc. Communication related data may also be included, e.g., data collected from channel monitoring such as signal strength, background noise level, metrics for interference problems, retry counter, association failure rate, packet demodulation failure rate, etc.

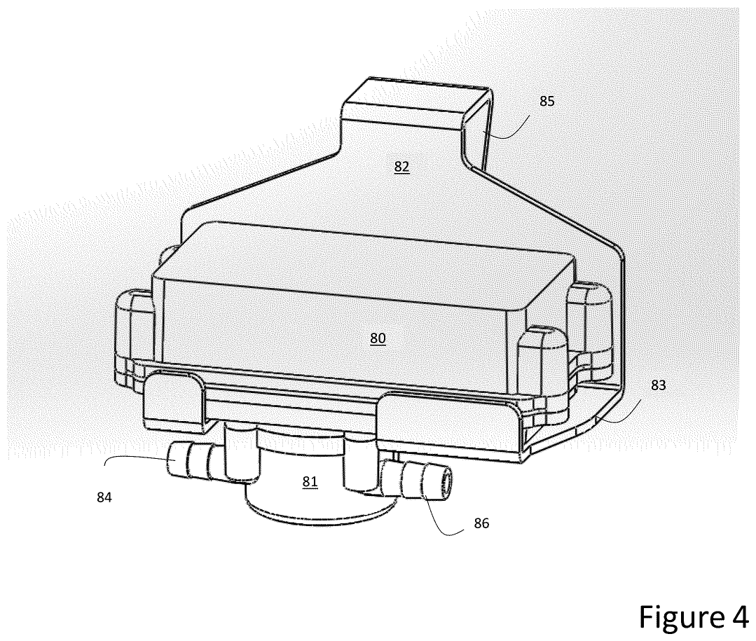

FIG. 4 depicts a further embodiment of a two-module sensor system having a dry module 80 and a wet module 81 configured to mount on a back wall/top edge of a toilet tank or the like (not shown) with integrated mounting bracket 82. The system likewise includes intake 84 and outflow 86 nozzles for receiving and expelling a flow of water via a fill tube and an overflow tube (not shown). Integrated mounting bracket 82 includes an arm 85 and an interface shelf 83 onto which the dry and wet modules connect, either separately or as a single unit. By integrating the sensor with the bracket in this manner, the together, either module can be removed and replaced without disturbing or removing the other module from the bracket. In certain embodiments, the interface shelf 83 may include a physical interface that partially or fully separates the two modules. In various embodiments, interface shelf 83 may include a passive transmission element to enhance the magnetic field for the Hall sensor, such as that provided under the tradename MagSafe®.

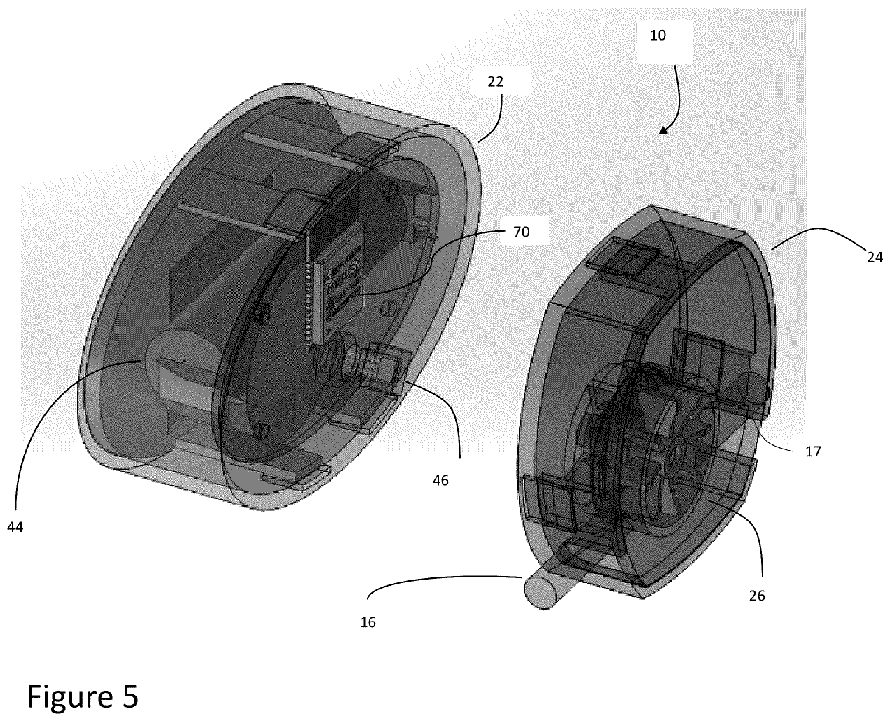

FIG. 5 depicts a see though view of modules of an additional embodiment of a two-module sensor system 10. The dry module 22 receives wheel rotation information from the wet module 24 via wireless magnetic transmissions. The rotation information is communicated via magnetic signal generated by the turbine 26 in the wet module 24 and received by a Hall effect sensor or an alike sensor in the event processing system 70 of the dry module 22.

The two modules may releasably connect in any manner, e.g., using tabs, screws, fasteners, snap connectors, adhesives, magnets, threaded sections, keyed sections, etc., or any combination of these. In the embodiment illustrated in FIG. 5, a tab 46 on the exterior of the dry module 22 may utilized to mate with a recess in wet module 24.

As noted, an advantage of two separate components that can be easily connected and disconnected is that it allows the dry module 22 to be replaced without removing the wet module 24, which is physically connected to components of the toilet. The dry module 22 contains the electronics including the power supply 44, event processing system 70, and is maintained in a separate, watertight, and sealed enclosure, which is not exposed to the surrounding environment.

The wet module 24, though which water passes, includes an intake port 16 for receiving a flow of water, a turbine 26 which rotates in response to water flow, and an outflow port 17. In this embodiment, the intake and outflow ports 16, 17 have the same dimension for attachment to two sections of a flexible fill tube. Water flows through a first section of the flexible fill tube (not shown) into intake port 16, through the turbine or wheel 26, exits via outflow port 17, through a second section of the flexible fill tube (not shown) and into the overflow tube (not shown). Installation can for example be achieved by simply cutting the existing fill tube and inserting the module between the cuts.

In embodiments such as that shown in FIG. 1, the device may include an intake port connectable to a fill tube and an outflow port configured to direct water out and down the overflow tube. In various embodiments, the intake and outflow ports can be implemented in any size to receive and expel fluid to different sized pipes, tubes, channels, tanks, etc.

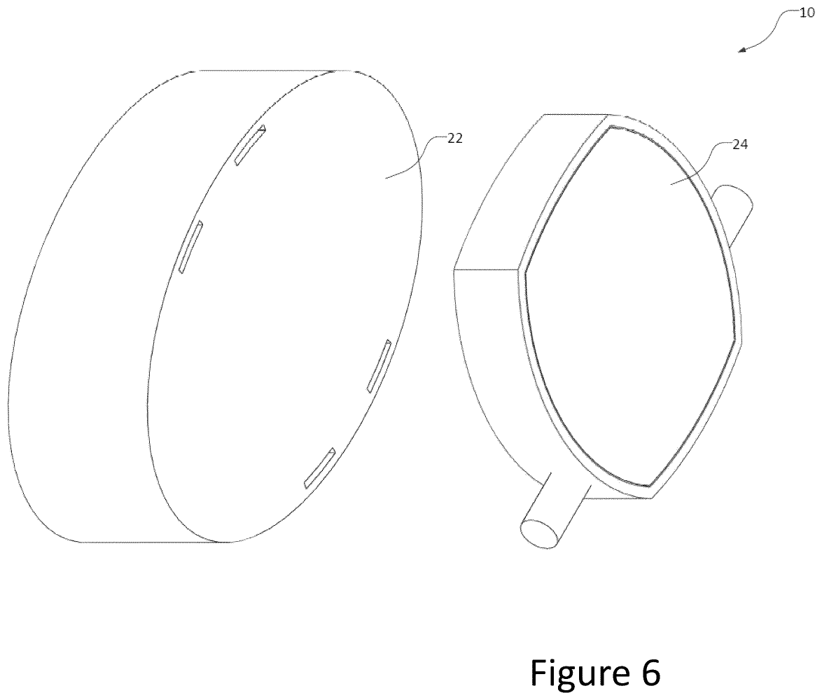

FIG. 6 depicts a further perspective view of the two-part device 10.

The two components may utilize a modular approach that allows for different sized and shaped wet/dry modules to be releasably connected together with a universal connection platform, e.g., using male/female connectors of a predetermined size/configuration. Accordingly, different modules can be connected, removed, replaced, upgraded, etc. For instance, different types of wet modules could allow for different sized tubes and turbines. The wet half can be reconfigured for different size flows by swapping out the wet half and updating a few software settings. Different types of dry modules could allow for different types of power and communication modalities, e.g., wired or wireless technologies including Wi-Fi, BLE, LoRa, LoRaWAN, LTE, 5G, 6G, Zigbee, IR, radio frequency-based systems including multiple radio configurations and beam steering technologies. A device can be reconfigured for a desired communications technology simply by selecting a different dry module.

The dry module can be designed and/or orientated in such a way to maximize signal strength and/or to enable the support for an external antenna. The dry module may have built-in functionality to simplify deployment in noisy environments, e.g., chips, servers or software for active RF survey data collection and analysis.

In some embodiments, the dry side electronics are put into a power down mode until flow is detected to save the battery. Flow detection can be done on the dry side through the casing with no physical connectors. Two illustrative approaches include: 1) Monitoring vibrations from the wet fluid side with a device like a piezo sensor; and 2) Using the hall sensor to periodically check for flow. Because of high power consumption when the hall sensor is powered, the second approach can periodically read the hall sensor with an extremely low power chip and look for signal changes, which detect flow and initiate a flow event. Once flow is detected, the hall sensor is powered continuously, and the output pulses are counted.

It is noted that the two-module sensor systems described herein can be configured for analyzing any type of configuration of fluid flow, and can be adapted in any configuration or manner along any fluid flow path, e.g., fill tube, overflow tube, pipe, channel, hose, drain, faucet, etc. Furthermore, the sensor system can be utilized with different types of fluid, e.g., liquid, gas, mixtures, natural gas, propane, heating oil, etc.

Additionally, while the wet module is described herein to include a turbine and magnets to generate a magnetic field in response to a fluid flow, it is understood that other types of devices and signals could be used. For example, any type of actuator that moves in response to a fluid flow could be utilized, e.g., a pendulum, a flap, a screw, a material. Moreover, any type of wireless transmission may be utilized to transmit signals from wet module to the dry module using any type of carrier wave or field, e.g., acoustic, vibration, light, magnetic, radio frequency field signals, etc.

Computing and processing systems utilized herein may comprise any type of computing device, integrated circuit, analog device, and for example includes at least one processor, memory, an input/output (I/O) (e.g., one or more I/O interfaces and/or devices), and a communications pathway. In general, processor(s) execute program code which is at least partially fixed in memory. While executing program code, processor(s) can process data, which can result in reading and/or writing transformed data from/to memory and/or I/O for further processing. The pathway provides a communications link between each of the components in computing system. I/O 64 can comprise one or more human I/O devices, which enable a user to interact with computing system. Computing system may also be implemented in a distributed manner such that different components reside in different physical locations.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to an individual in the art are included within the scope of the disclosure as defined by the accompanying claims.

1. A fluid flow sensor system, comprising:
a first module that generates magnetic field signals in response to a fluid passing therethrough; and
a second module, sealed from the first module, that includes:
a sensor for capturing the magnetic field signals, and
an event processor system coupled to the sensor and configured to process the magnetic field signals to generate flow data associated with the fluid.

2. The fluid flow sensor system of claim 1, wherein the first module includes:
an intake port for receiving the fluid;
a turbine that spins in response to the fluid moving therethrough, the turbine having magnets that spin and create the magnetic field signals; and
an outflow port for expelling the fluid.

3. The fluid flow sensor system of claim 1, wherein the second module comprises a fully enclosed module sealed from a surrounding environment.

4. The fluid flow sensor system of claim 3, wherein the second module is releasably connectable to the first module.

5. The fluid flow sensor system of claim 3, wherein the first module and second modules are implemented in a single unit connected via a common wall, and wherein the first module is sealed from a surrounding environment.

6. The fluid flow sensor system of claim 1, wherein the sensor comprises a hall effect sensor.

7. The fluid flow sensor system of claim 1, wherein fluid comprises either a gas or a liquid.

8. The fluid flow sensor system of claim 2, wherein the intake port is configured to connect to and receive water from a toilet fill tube.

9. The fluid flow sensor system of claim 8, wherein the outflow port is configured to expel water to a toilet overflow tube.

10. The fluid flow sensor system of claim 1, wherein the first module includes a power management system, a communication system and a data processing system.

11. A fluid flow sensor system, comprising:
a first module that generates a wireless signal in response to a fluid passing therethrough; and
a second module, sealed from the first module, that includes:
a sensor for capturing the wireless signal, and
an event processor system coupled to the sensor and configured to process the wireless signal to generate flow data associated with the fluid.

12. The fluid flow sensor system of claim 11, wherein the wireless signal comprises one of an acoustic signal, a vibration signal, a light signal, and a radio frequency signal.

13. The fluid flow sensor system of claim 11, wherein the first module includes:
an intake port for receiving the fluid;
an actuator that moves in response to the fluid moving therethrough and creates the wireless signal; and
an outflow port for expelling the fluid.

14. The fluid flow sensor system of claim 13, wherein the second module comprises a fully enclosed module sealed from a surrounding environment that is releasably connectable to the first module.

15. The fluid flow sensor system of claim 13, wherein the first module and second modules are implemented in a single unit connected via a common wall, and wherein the first module is sealed from a surrounding environment.

16. The fluid flow sensor system of claim 11, wherein fluid comprises either a gas or a liquid.

17. The fluid flow sensor system of claim 13, wherein the intake port is configured to connect to and receive water from a toilet fill tube and the outflow port is configured to expel water to a toilet overflow tube.

18. The fluid flow sensor system of claim 11, wherein the first module includes a power management system, a communication system and a data processing system.

19. A toilet, comprising:
a first module that generates magnetic field signals in response to a fluid passing therethrough; and
a second module, sealed from the first module, that includes:
a sensor for capturing the magnetic field signals, and
an event processor system coupled to the sensor and configured to process the magnetic field signals to generate flow data associated with the fluid.

20. The toilet of claim 19, wherein the first module includes:
an intake port for receiving the fluid;
a turbine that spins in response to the fluid moving therethrough, the turbine having magnets that spin and create the magnetic field signals; and
an outflow port for expelling the fluid.
